(19) United States
(12) Patent Application Publication
(10) Pub. No.: US 2008/0043107 A1
(43) Pub. Date: Feb. 21, 2008

(54) Mediation Device and Method for Remotely Controlling a Camera of a Security System Using Dual-Tone Multi-Frequency (DTMF) Signals

(75) Inventors: John M. Coogan, Lansdale, PA (US); Jeffrey D. Ollis, Dresher, PA (US)

Correspondence Address: Motorola, Inc.;Law Department, 1303 East Algonquin Road, 3rd Floor, Schaumburg, IL, 60196, US

(73) Assignees: John M. Coogan, Lansdale, PA (US); Jeffrey D. Ollis, Dresher, PA (US)

(21) Appl. No.: 11/461,875

(22) Filed: Aug. 2, 2006

(51) Int. Cl. H04N 7/18

(52) U.S. Cl. 348/154

(57) ABSTRACT

A mediation device located in the user's home receives dual-tone multi-frequency (DTMF) signals via a Plane Old Telephone Service (POTS) connection and decodes the signals into signals that are used to control one or more cameras of the user's home security system. The mediation device may be a device that serves only this purpose, or it may be part of another device, such as, for example, an answering machine, a fax machine, or a cordless telephone.

### TECHNICAL FIELD OF THE INVENTION

The invention relates to communications networks. More particularly, the invention relates to using DTMF signals in a network to remotely control a camera of a security system using a mediation device that is in communications with the network.

### BACKGROUND OF THE INVENTION

Home security systems that include cameras for video surveillance have become increasingly popular in the last few years. These systems typically transmit the images captured by the camera wirelessly or over wires from the cameras to a television or display monitor for viewing by the user, or to a video recorder for recording the images, such as a Video Cassette Recorder (VCR). The user is able to monitor the images as they are captured in real time, or view saved images at a later time.

Some security systems allow the user to remotely view images captured by the cameras on a display monitor of a computer that is connected to the Internet. These systems do not, however, provide the user with the ability to remotely control the cameras, but simply enable the user to remotely view the images, which are typically displayed in a camera-by-camera sequence that cannot be changed by the user.

A need exists for a way to allow a user to remotely control one or more cameras of a home security system such that the user is able to control the capture of video images by the cameras and the transmission of the images to one or more remote locations.

### SUMMARY OF THE INVENTION

The invention provides a mediation device and method for remotely controlling one or more cameras of a security system using dual-tone multi-frequency (DTMF) signals. The mediation device is located at a user's premises and comprises an input port, a DTMF decoder, a processor, and an output port. The input port is configured to receive DTMF signals transmitted over the Public Switched Telephone Network (PSTN) to a Plain Old Telephone Service (POTS) connection at the user's premises. The DTMF decoder is configured to receive DTMF signals from the input port and to decode the DTMF signals to produce decoded DTMF signals. The processor is configured to receive the decoded DTMF signals from the DTMF decoder and to process the decoded DTMF signals in accordance with a camera control algorithm to produce camera control signals. The output port is configured to receive camera control signals produced by the processor and to output the camera control signals over a communications link to at least one camera of the security system to control one or more operations of the camera. The camera is connected to an Internet Protocol (IP) connection at the user's premises for sending one or more images captured by the camera over the Internet to one or more locations.

The method comprises receiving one or more DTMF signals transmitted over the PSTN to a POTS connection at the user's premises, decoding the DTMF signals to produce one or more decoded DTMF signals, processing the decoded DTMF signals in accordance with a camera control algorithm to produce camera control signals, and

outputting the camera control signals to at least one camera to control one or more operations of the camera The camera is connected to an IP connection at the user's premises for sending one or more images captured by the camera over the Internet to one or more locations.

The images captured by the camera or cameras may be sent to one or more of a variety of locations, such as, for example, an IP device connected to the Internet at an IP address, and a wireless device connected to a wireless network, which interfaces with the Internet via a gateway device. The devices that receive the images have the capability of displaying the images. Other data such as audio data, for example, may be sent with the images.

In accordance with an embodiment, the camera control algorithm is performed in by a software computer program being executed by a processor. In this case, the program comprises instructions for receiving decoded DTMF signals from a DTMF decoder, instructions for processing the decoded DTMF signals in accordance with a camera control algorithm to produce camera control signals, and instructions for causing the camera control signals to be outputted to at least one camera to control one or more operations the camera.

These and other features and advantages of the invention will become apparent from the following description, drawings and claims.

### BRIEF DESCRIPTION OF THE DRAWINGS

FIG. 1 illustrates a network diagram that demonstrates the connection of the mediation device of the invention to the Public Switched Telephone Network (PSTN) via a POTS connection, the communications link between the mediation device and at least one camera, and the connection of the camera to the Internet via an IP connection of the mediation device.

FIG. 2 illustrates a block diagram of the mediation device of the invention in accordance with an exemplary embodiment.

FIG. 3 illustrates a flowchart that demonstrates the method of the invention in accordance with an exemplary embodiment

### DETAILED DESCRIPTION OF THE INVENTION

In accordance with the invention, a mediation device located in the user's home receives dual-tone multi-frequency (DTMF) signals via a Plane Old Telephone Service (POTS) connection and decodes the signals into signals that are used to control one or more cameras of the user's home security system. The mediation device may be a device that serves only this purpose, or it may be part of another device, such as, for example, an answering machine, a fax machine, or a cordless telephone.

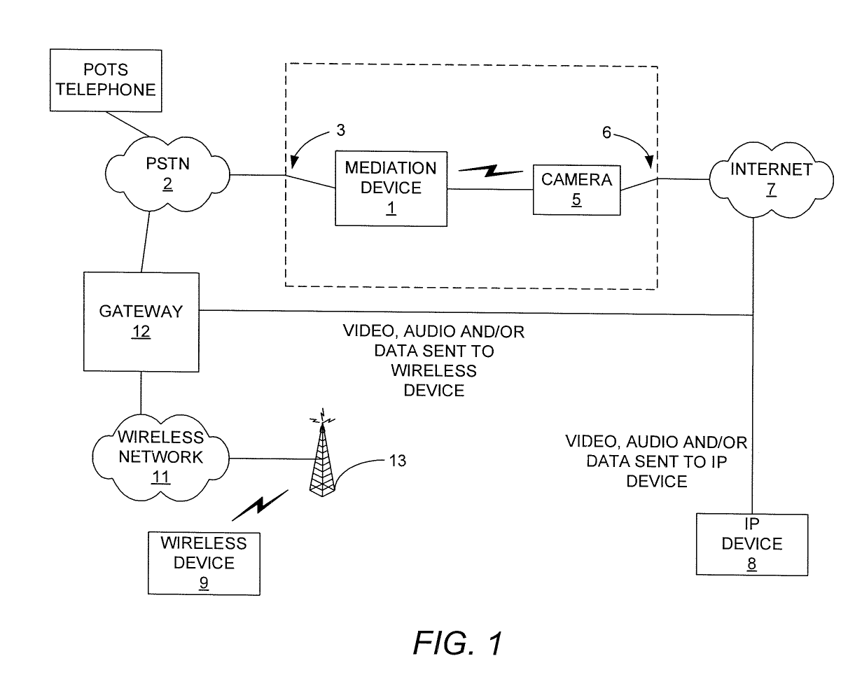

FIG. 1 illustrates a network diagram that demonstrates the connection of the mediation device 1 of the invention to the Public Switched Telephone Network (PSTN) 2 via a POTS connection 3, the communications link 4 between the mediation device 1 and at least one camera 5, and the connection of the camera 5 to the Internet 7 via an Internet connection 6. The location or locations to which images are sent may include, for example, an Internet Protocol (IP) address of an IP device 8 connected to the Internet 7 or a wireless network address of a wireless device 9 connected to a wireless network 11.

In accordance with the invention, the user is able to control the camera via the mediation device 1 by placing a call over the PSTN 2 from a POTS device 12 or from the wireless device 9. If the user places a call from the POTS device 12, which may be, for example, a cordless telephone connected to a POTS connection, the call is routed through the PSTN 2 and is connected to the mediation device 1 via the POTS connection 3 at the user's home. The user then presses one key or a series of keys on the POTS device 12 to cause respective DTMF signals to be generated. The mediation device 1 is configured to decode the DTMF signals and process the signals to produce control signals that are output to the camera 5 over the wired or wireless link 4. The camera 5 performs the functions indicated by the control signals and sends the video images via IP connection 6 over the Internet 7.

The control signals received by the camera 5 are capable of causing the camera 5 to perform one or more of a variety of functions, including, for example, outputting a current video frame, changing a viewing angle, zooming in, zooming out, etc. If the security system includes multiple cameras, the control signals may select a particular one of the cameras to perform one or more of these functions.

The control signals preferably also indicate to the camera 5 a location to which the image is to be sent. For example, if the control signals indicate that the image is to be sent to IP device 8, the camera 5 will output IP packets that include the IP address of the IP device 8. If the control signals indicate that the image is to be sent to wireless device 9, the camera 5 will output IP packets that include an address of the wireless device 9, which is typically the Mobile Station International Subscriber Directory Number (MSISDN) of the wireless device 9. The IP packets are routed through the Internet 7 to a gateway device 12, which Interfaces the Internet 7 with the wireless network 11 and with the PSTN 2. The gateway device 12 then routes the packets to the wireless network 11, which routes the packets via base station 13 to wireless device 9.

The user is also able to control the camera 5 via the mediation device 1 by placing a call over the wireless network 11 from the wireless device 9, which may be, for example, a cellular telephone, a personal digital assistant, a laptop computer having wireless capability, etc. If the user places a call from the wireless device 9, the call is routed via base station 13 to the wireless network 11, which routes the call to gateway device 12. The gateway device 12 routes the call to the PSTN 2, which connects the call to the mediation device 1 via POTS connection 3. The user then selects one key or a series of keys on the wireless device 9 to cause respective DTMF signals to be generated. The mediation device 1 decodes the DTMF signals and processes the signals to produce control signals that are output to the camera 5 over the wired or wireless link 4. The camera 5 performs the functions indicated by the control signals and sends the video images via IP connection 6 over the Internet 7 to the location indicated by the control signals, e.g., IP device 8 and/or wireless device 9.

Most wireless devices currently being sold have display screens and the capability of displaying video images on the display screens. The images are typically streamed to the wireless device rather than downloaded to the wireless device due to storage capacity limitations of the wireless device. Assuming the wireless device 9 has the capability of displaying video images, the invention allows the user to place a call from the wireless device 9 and select a key or series of keys that produce DTMF signals that cause the camera 5 to send a real-time video image to the wireless device 9 that is displayed on the display screen of the wireless device 9. The user can also simultaneously cause the images to be sent to IP device 9, which may be, for example, a PC at the user's office.

The camera 5 may be capable of sending voice, audio and/or image data in addition to sending video data to the location indicated by the control signals received from the mediation device 1. The camera 5 may be, for example, an analog camera, an IP camera, a camera of a video telephone, etc. The invention is not limited with respect to the number of cameras that are used or with respect to the type of camera or cameras that is used. The invention also is not limited with respect to the location or locations to which the video and any other data are sent.

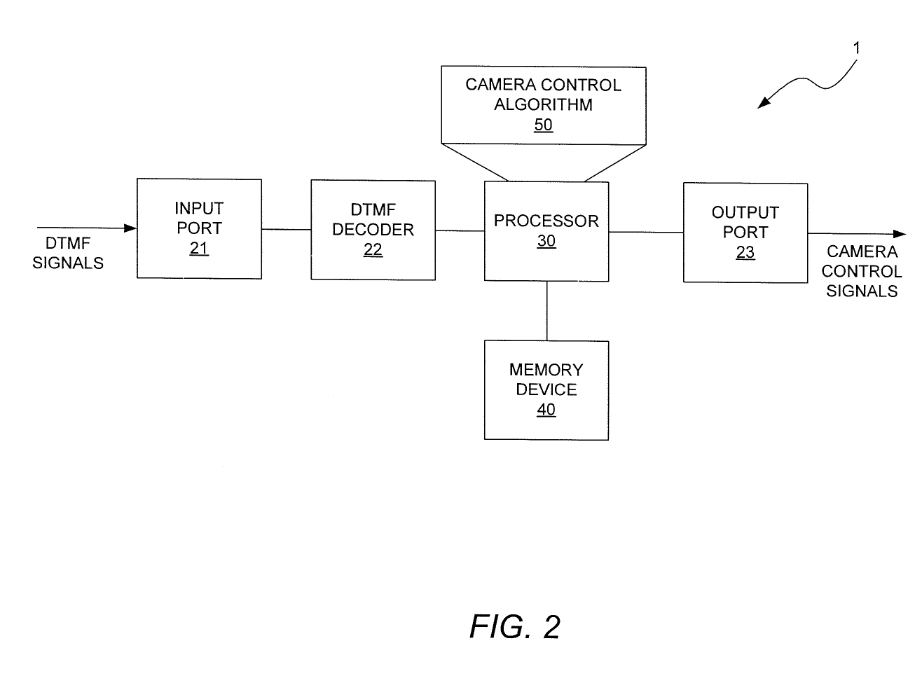

FIG. 2 illustrates a block diagram of the mediation device 1 of the invention in accordance with an exemplary embodiment. The mediation device 1 includes an input port 21, a DTMF decoder 22, an output port 23, a processor 30, and a memory device 40. The input port 21 receives DTMF signals from the POTS connection 3. The DTMF decoder 22 decodes the DTMF signals into digital signals suitable for processing by the processor 30. The processor 30 processes the digital signals in accordance with a camera control algorithm 50 to generate camera control signals. The processor 30 outputs the camera control signals via output port 23 to the camera or cameras. The camera or cameras then perform the functions indicated by the camera control signals received from the output port 32.

The processor 30 is typically a microprocessor that performs the algorithm 50 by executing a software computer program. However, the algorithm 50 may also be performed solely in hardware or in a combination of hardware and software or firmware. The processor 30 may be any type of computational device, including, for example, a microprocessor, a microcontroller, a programmable gate array, a programmable logic array, an application specific integrated circuit (ASIC), a system on a chip (SOC), etc. The software program may be stored in memory device 40, which may be any type of computer-readable medium, including, for example, random access memory (RAM), dynamic RAM (DRAM), flash memory, read only memory (ROM) compact disk ROM (CD-ROM), digital video disks (DVDs), magnetic disks, magnetic tapes, etc. The invention also encompasses electrical signals modulated on wired and wireless carriers (e.g., electrical conductors, wireless carrier waves, etc) in packets and in non-packet formats.

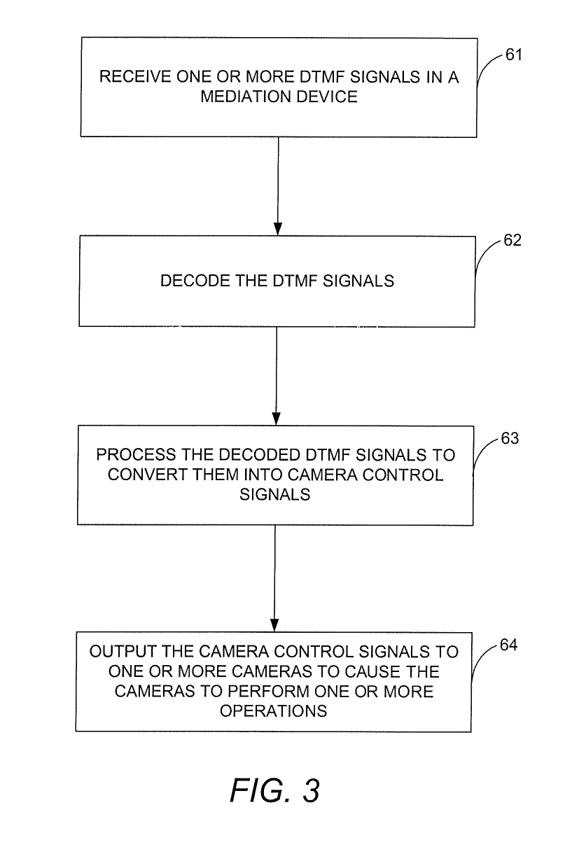

FIG. 3 illustrates a flowchart that demonstrates the method of the invention performed by the mediation device 1 in accordance with an exemplary embodiment. The mediation device 1 receives one or more DTMF signals, as indicated by block 61. The mediation device 1 decodes the DTMF signals, as indicated by block 62. The decoded DTMF signals are then processed in accordance with a camera control algorithm to convert the DTMF signals into camera control signals, as indicated by block 63. The camera control signals are then output to one or more cameras to cause the cameras to perform one or more operations, including sending video data via the IP connection of the mediation device 1 over the Internet, as indicated by block 64.

As stated above, the mediation device may be a dedicated device that performs no functions other than camera control, or it may be incorporated into various types of existing devices, such as, for example, answering machines, facsimile machines and cordless telephones. These devices typically include a DTMF decoder that may be used by the mediation device 1 to decode DTMF signals. These devices typically also include a processor that processes the decoded DTMF signals. This processor may be configured or programmed to perform the camera control algorithm 50 in addition to performing the algorithms that are normally performed by the processor. Therefore, the mediation device 1 may easily be incorporated into these and other types of devices

It should be noted that the invention has been described with reference to exemplary embodiments for the purpose of demonstrating the principles and concepts of the invention. Those skilled in the art will understand, in view of the description provided herein, that the invention is not limited to these exemplary embodiments and that modifications can be made to the embodiments described herein and that all such modifications are within the scope of the invention.

What is claimed is:

1. A mediation device for remotely controlling one or more cameras of a security system using dual-tone multi-frequency (DTMF) signals, the mediation device being located at a user's premises the mediation device comprising:
an input port configured to receive DTMF signals transmitted over a Public Switched Telephone Network (PSTN) to a Plain Old Telephone Service (POTS) connection at the user's premises;
a DTMF decoder configured to receive DTMF signals from the input port and to decode the DTMF signals to produce decoded DTMF signals;
a processor configured to receive decoded DTMF signals from the DTMF decoder and to process the decoded DTMF signals in accordance with a camera control algorithm to produce camera control signals; and
an output port configured to receive camera control signals produced by the processor and to output the camera control signals over a communications link to at least one camera of the security system to control one or more operations of said at least one camera, said at least one camera being connected to an Internet Protocol (IP) connection at the user's premises for sending one or more images captured by said at least one camera over an Internet to one or more locations.

2. The mediation device of claim 1, wherein the DTMF signals transmitted over the PSTN originate from a POTS telephone connected to the PSTN.

3. The mediation device of claim 1, wherein the DTMF signals transmitted over the PSTN originate from a wireless device and are communicated over a wireless network to a gateway device that connects the wireless network to the PSTN.

4. The mediation device of claim 1, wherein said communications link is a wired communications link.

5. The mediation device of claim 1, wherein said communications link is a wireless communications link.

6. The mediation device of claim 1, wherein the camera control signals output to said at least one camera cause one or more images captured by said at least one camera to be sent over the Internet to an Internet device located at an IP address on the Internet, the Internet device having the ability to display said one or more images.

7. The mediation device of claim 1, wherein the camera control signals output to said at least one camera cause one or more images captured by said at least one camera to be sent over the Internet to a wireless network via a gateway device to a wireless device having an address on the wireless network, the wireless device having the ability to display said one or more images.

8. The mediation device of claim 6, wherein audio data is sent along with said one or more images.

9. The mediation device of claim 7, wherein audio data is sent along with said one or more images.

10. The mediation device of claim 1, wherein said one or more operations include sending a flame of recently captured video images over the Internet to one or more locations.

11. The mediation device of claim 1, wherein said one or more images are sent to at least a first location and at least a second location, the first location being an Internet device located at an IP address on the Internet, the Internet device having the ability to display said one or more images, the second location being a wireless device having an address on the wireless network, the wireless device having the ability to display said one or more images, wherein said one or more images are sent over the Internet to the wireless network via a gateway device.

12. A method for remotely controlling one or more cameras of a security system using dual-tone multi-frequency (DTMF) signals, the security system being located at a user's premises, the method comprising:
receiving one or more DTMF signals transmitted over a Public Switched Telephone Network (PSTN) to a Plain Old Telephone Service (POTS) connection at the user's premises;
decoding said one or more DTMF signals to produce one or more decoded DTMF signals;
processing the decoded DTMF signals in accordance with a camera control algorithm to produce camera control signals; and
outputting the camera control signals to at least one camera to control one or more operations of said at least one camera, said at least one camera being connected to an Internet Protocol (IP) connection at the user's premises for sending one or more images captured by said at least one camera over an Internet to one or more locations.

13. The method of claim 12, wherein the DTMF signals transmitted over the PSTN originate from a POTS telephone connected to the PSTN.

14. The method of claim 12, wherein the DTMF signals transmitted over the PSTN originate from a wireless device and are communicated over a wireless network to a gateway device that connects the wireless network to the PSTN.

15. The method of claim 12, wherein the camera control signals output to said at least one camera cause one or more images captured by said at least one camera to be sent over the Internet to an Internet device located at an IP address on the Internet, the Internet device having the ability to display said one or more images.

16. The method of claim 12, wherein the camera control signals output to said at least one camera cause one or more images captured by said at least one camera to be sent over the Internet to a wireless network via a gateway device to a wireless device having an address on the wireless network, the wireless device having the ability to display said one or more images.

17. The method of claim 15, wherein audio data is sent along with said one or more images.

18. The method of claim 16, wherein audio data is sent along with said one or more images.

19. The method of claim 12, wherein said one or more operations include sending a frame of recently captured video images over the Internet to one or more locations.

20. The method of claim 12, wherein said one or more images are sent to at least a first location and at least a second location, the first location being an Internet device located at an IP address on the Internet, the Internet device having the ability to display said one or more images, the second location being a wireless device having an address on the wireless network, the wireless device having the ability to display said one or more images, wherein said one or more images are sent over the Internet to the wireless network via a gateway device.

21. A computer program for remotely controlling one or more cameras of a security system using dual-tone multi-frequency (DTMF) signals, the security system being located at a user's premises, the computer program comprising computer instructions that are stored on a computer-readable medium, the program comprising:
instructions for receiving decoded DTMF signals from a DTMF decoder, the decoded DTMF signals being produced by a DTMF decoder that receives and decodes DTMF signals transmitted over a Public Switched Telephone Network (PSTN) to a Plain Old Telephone Service (POTS) connection at the user's premises;
instructions for processing the decoded DTMF signals in accordance with a camera control algorithm to produce camera control signals; and
instructions for causing the camera control signals to be outputted to at least one camera to control one or more operations of said at least one camera, said at least one camera being connected to an Internet Protocol (IP) connection at the user's premises for sending one or more images captured by said at least one camera over an Internet to one or more locations.
